(19) United States
(12) Patent Application Publication
(10) Pub. No.: US 2019/0301358 A1
(43) Pub. Date: Oct. 3, 2019

(54) Turbocharger

(71) Applicant: MAN Energy Solutions SE, Augsburg (DE)

(72) Inventors: Lukás BOZEK, Pribyslavice (CZ); Björn HOSSBACH, Diedorf (DE); Tobias WEISBROD, Augsburg (DE); Paul SCHORER, Offingen (DE); Jan REZANINA, Namest nad Oslavou (CZ)

(21) Appl. No.: 16/465,870

(22) PCT Filed: Aug. 31, 2017
(86) PCT No.: PCT/EP2017/071862

§ 371 Date: May 31, 2019

(30) Foreign Application Priority Data
Dec. 1, 2016 (DE) 10 2016 123 250.5

(51) Int. Cl. F02B 39/00; F02B 37/00

(52) U.S. Cl. CPC F02B 39/00; F02B 37/00

(57) ABSTRACT

A turbocharger having a turbine, a compressor, and a bearing housing The turbine has a turbine housing, a nozzle ring, and a turbine rotor. The A fastening device a first and second section. The turbine housing and the bearing housing are connected via the fastening device mounted on the flange of the turbine housing by the first section and covers the flange of the bearing housing by the second section. The nozzle ring is installed such that a flange thereof is positioned, relative to a flow channel, on a side of the flow channel opposite the flange of the turbine housing. The structure avoids trenching effects and leakage between the turbine and bearing housing can thus be reduced.

### CROSS REFERENCE TO RELATED APPLICATIONS

This is a U.S. national stage of application No. PCT/EP2017/071862, filed on Aug. 31, 2017. Priority is claimed on German Application No. DE102016123250.5, filed Dec. 1, 2016, the content of which is incorporated herein by reference.

### BACKGROUND OF THE INVENTION

### 1. Field of the Invention

The invention relates to a turbocharger.

### 2. Description of the Prior Art

From DE 10 2013 002 605 A1, the fundamental construction of a turbocharger is known. A turbocharger comprises a turbine in which a first medium is expanded and a compressor in which a second medium is compressed utilising the energy extracted in the turbine during the expansion of the first medium. The turbine of the turbocharger comprises a turbine housing and a turbine rotor. The compressor of the turbocharger comprises a compressor housing and a compressor rotor. Between the turbine housing of the turbine and the compressor housing of the compressor a bearing housing is positioned, wherein the bearing housing on the one side is connected to the turbine housing and on the other side to the compressor housing. In the bearing housing, a shaft is mounted via which the turbine rotor is coupled to the compressor rotor.

From practice it is known that the turbine housing of the turbine, namely a so-called turbine inflow housing, and the bearing housing are connected to one another via a fastening device designed as a clamping claw. Such a fastening device, which is preferentially designed as a clamping claw, is mounted with a first section of the same to a flange of the turbine housing via fastening elements and, with a second section, covers a flange of the bearing housing at least in sections. By way of such a fastening device, the combination of bearing housing and turbine housing is braced, in particular while clamping a flange of a nozzle ring and if required a flange of a heat shield between the flange of the turbine housing and the flange of the bearing housing.

The turbine housing is filled with the first medium to be expanded, in particular with exhaust gas to be expanded. The turbine inflow housing of the turbine housing conducts the exhaust gas towards the turbine rotor. In the turbine inflow housing there is a positive pressure relative to the surroundings, which in the turbine is removed subject to extracting energy during the expansion of the first medium. In the region of the connection of turbine housing or turbine inflow housing and bearing housing a leakage can occur, so that the first medium to be expanded in the turbine can enter the surroundings via the connecting region between turbine housing and bearing housing. This is disadvantageous.

In order to counteract such a leakage of the first medium to be expanded in the turbine, the bracing between turbine housing or turbine inflow housing and bearing housing is increased, in particular via higher tightening torques for the fastening elements, via which the fastening device that is preferentially designed as clamping claw is mounted to the turbine housing. This also increases a clamping force between the fastening device and the bearing housing. A contact point between the bearing housing and the fastening device is exposed to high relative movements as a consequence of different thermal expansions of bearing housing and turbine housing or turbine inflow housing. Combined with a high contact pressure or a high preload or a high clamping force between the bearing housing and the fastening device, a wear on the fastening device and/or on the bearing housing can occur as a consequence of a so-called trenching effect. This can cause the first medium to be expanded in the turbine to leak into the surroundings.

### SUMMARY OF THE INVENTION

An object of one aspect of the present invention is creating a turbocharger with a new type of flange connection.

According to one aspect of the invention a nozzle ring is installed in such a manner that a flange of the same is positioned, based on a flow passage, on a side of the flow passage located opposite the flange of the turbine housing, which is braced with the flange of the bearing housing. By way of this, the number of the components in the connecting region or bracing region of turbine housing or turbine inflow housing and bearing housing is reduced. By way of this, a particularly advantageous sealing of the connection of turbine housing or turbine inflow housing and bearing housing is possible. The risk that medium to be expanded in the turbine enters the surroundings via the connecting region between turbine housing and bearing housing is reduced.

According to one aspect of the invention a spring element is positioned between the flange of the bearing housing and the flange of the turbine housing, which axially presses the flange of the nozzle ring against the flange of the turbine housing. By way of this, a particularly advantageous sealing of the connection of turbine housing or turbine inflow housing and bearing housing is also possible. The risk that medium to be expanded in the turbine enters the surroundings via the connecting region between turbine housing and bearing housing is reduced.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1: is a cross section by way of an extract through a turbocharger in a region of a connection of a turbine housing to a bearing housing;

FIG. 2: is a cross section by way of an extract through a turbocharger in a region of a connection of a turbine housing to a bearing housing; and

FIG. 3: is a cross section by way of an extract through a turbocharger in a region of a connection of a turbine housing to a bearing housing.

### DETAILED DESCRIPTION OF THE PRESENTLY PREFERRED EMBODIMENTS

The invention relates to a turbocharger.

A turbocharger comprises a turbine for expanding a first medium, in particular for expanding exhaust gas of an internal combustion engine and a compressor for compressing a second medium, in particular charge air, namely utilising energy extracted in the turbine during the expansion of the first medium. Here the turbine comprises a turbine housing and a turbine rotor. The compressor comprises a compressor housing and a compressor rotor. The compressor rotor is coupled to the turbine rotor via a shaft which is mounted in a bearing housing, wherein the bearing housing is positioned between the turbine housing and the compressor housing and connected both to the turbine housing and to the compressor housing. The person skilled in the art addressed here is familiar with this fundamental construction of a turbocharger.

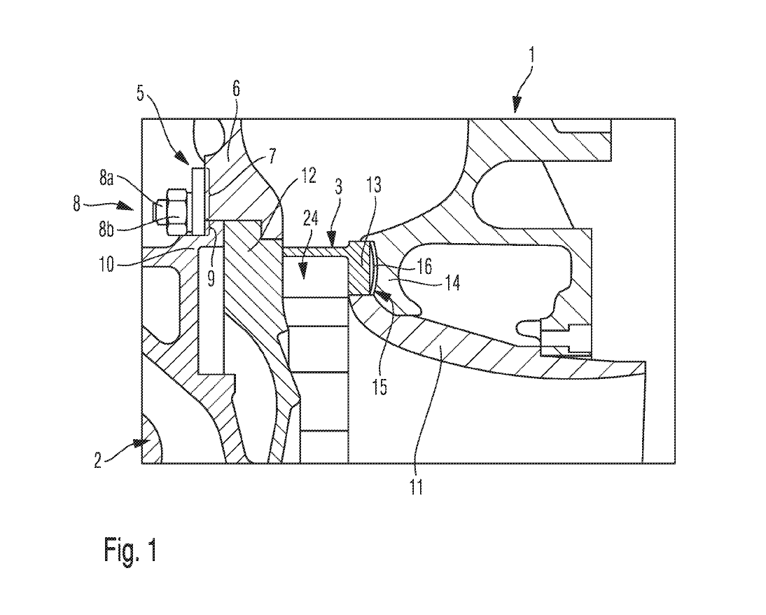

One aspect of the invention relates to such details of a turbocharger which relate to the connection of turbine housing of a turbine preferentially designed as a radial turbine and bearing housing of a turbocharger. In the following, making reference to FIGS. 1 to 3, exemplary turbochargers are described, wherein FIGS. 1 to 3 each show relevant extracts from a turbocharger in the region of the connection of the turbine housing to the bearing housing.

A first turbocharger according to a first aspect of the invention is shown by FIG. 1, wherein in FIG. 1 the connection between a turbine housing, namely of a turbine inflow housing 1 of the turbine housing and a bearing housing 2 of the exhaust gas turbocharger is shown. Furthermore, FIG. 1 shows a nozzle ring 3, a heat shield 4 and a so-called insert piece 11.

The turbine inflow housing 1 is connected to the bearing housing 2 via a fastening device 5 in such a manner that the fastening device 5 is mounted to a flange 6 of the turbine inflow housing 1 with a first section 7, namely via multiple fastening elements 8, and that the fastening device 5, with a second section 9, covers a flange 10 of the bearing housing 2 at least in sections. The fastening device 5 is also referred to as clamping claw and braces the turbine inflow housing 1 and bearing housing 2 with one another. Seen in the circumferential direction, the fastening device 5 can be segmented.

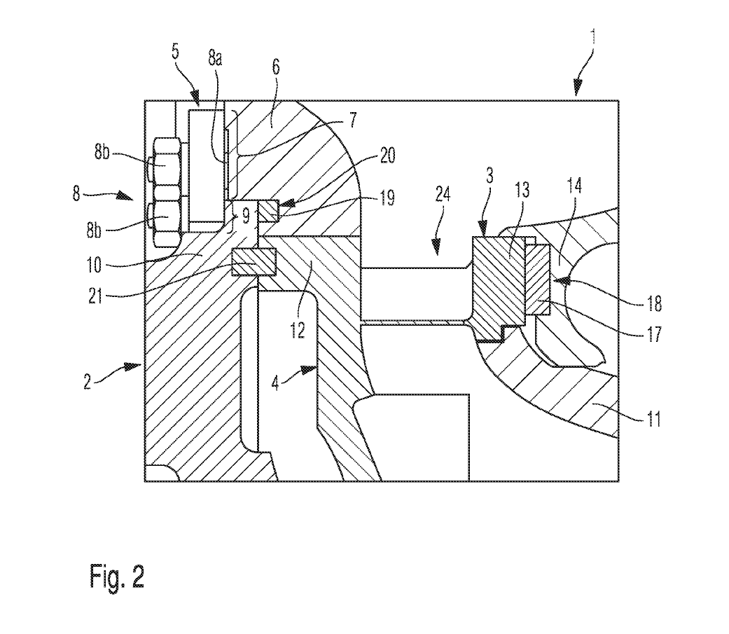

In the exemplary embodiment shown in FIGS. 1 and 2, each fastening elements 8 comprises a threaded screw 8 a screwed into the flange 6 of the turbine inflow housing 1 and a nut 8 b acting on the other end of the threaded screw 8a, whereby by tightening the nut 8 b a defined preload force can be exerted on the turbine inflow housing 1 and on the bearing housing 10 via the fastening device 5.

In the exemplary embodiment of an exhaust gas turbocharger according to the first aspect of the invention present here shown in FIG. 1, the nozzle ring 3 of the turbine is installed in such a manner that a flange 13 of the nozzle ring 3, based on a flow passage 24 of the turbine, in the region of which the nozzle ring 3 is arranged, is positioned on a side of the flow passage 24 located opposite the flange 6 of the turbine inflow housing 1 and thus of the flange 10 of the bearing housing 2.

Accordingly, exclusively a flange 12 of the heat shield 4 is clamped in the exemplary embodiment of FIG. 1, between the flange 10 of the turbine inflow housing 1 that is braced between the fastening device 5 and the flange 10 of the bearing housing 2. By contrast, the flange 13 of the nozzle ring 3 is no longer clamped in this bracing region of bearing housing 1 and turbine inflow housing 2 between the flanges 6, 10, as a result of which the number of the components in the bracing combination is reduced and a clearly defined tightening point is created in the bracing combination. By way of this, the risk that exhaust gas enters the surroundings via the connecting region between the flanges 6, 10 of turbine inflow housing 1 and bearing housing 2 can be reduced.

The flange 13 of the nozzle ring 3 can be fastened on a section 14 of the turbine inflow housing 1, which just like the flange 13 of the nozzle ring 3, based on the flow passage 24 is positioned on the side of the flow passage 24 which in the bracing region between the flanges 6, 10 of turbine inflow housing 1 and bearing housing 2 is located opposite.

In the exemplary embodiment of FIG. 1, the flange 13 of the nozzle ring 3 engages at least in sections in a recess 15 of this section 14 of the turbine inflow housing 1, wherein the flange 13 of the nozzle ring 3, seen in the radial direction, supports itself with an end on a boundary of this recess 15 of the section 14 of the turbine inflow housing 1 and at an end located opposite on the insert piece 11. In the recess 15 of the section 14 of the turbine inflow housing 1, on which the flange 13 of the nozzle ring 3 is supported, an elastic spring element 16 is received which presses the flange 13 of the nozzle ring 3 in the axial direction. Here, this elastic spring element 16 presses against the flange 13 of the nozzle ring 3 in such a manner that the nozzle ring 3 is pressed from the spring element 16 in the direction of the connecting region of the flanges 6, 10 of turbine inflow housing 1 and bearing housing 2. In the exemplary embodiment of FIG. 1, the nozzle ring 3 presses against the flange 12 of the heat shield 4.

A turbocharger according to an aspect of the invention is shown FIG. 2. In FIG. 2, the flange 13 of the nozzle ring 3 is also positioned on a side of the flow passage 24 of the turbine located opposite the bracing region of the flanges 6, 10 of turbine inflow housing 1 and bearing housing 2.

The exemplary embodiment of FIG. 2 differs from the exemplary embodiment of FIG. 1 in that in FIG. 2 the flange 13 of the nozzle ring 3 is mounted on the section 14 of the bearing housing 1 via a fastening device designed as a feather key 17, which is received in a corresponding recess 18 of the section 14 of the bearing housing 1. In FIG. 2, the flange 13 of the nozzle ring 3 also projects into the recess 18 of the section 4 of the turbine inflow housing 1 at least in sections.

A further distinction of the exemplary embodiment of FIG. 2 from the exemplary embodiment of FIG. 1 consists in that in FIG. 2 the flange 12 of the heat shield 4 is not clamped between the flanges 6, 10 of turbine inflow housing 1 and bearing housing 2. The flange 10 of the bearing housing 2 in FIG. 2 rather comes to lie directly against the flange 6 of the turbine inflow housing 1.

In this sealing region between the flange 10 of the bearing housing 2 and the flange 6 of the turbine inflow housing 1, a sealing element 19 can be additionally positioned, which can preferentially be a metallic sealing ring in the form of an O-ring or C-ring. The sealing element 19 can also be produced from graphite. In FIG. 2, the sealing element 19 is received in a recess 20 of the flange 6 of the turbine inflow housing 1 and seals in particular in the axial direction between sealing faces of the flanges 6, 10 of turbine inflow housing 1 and bearing housing 2 lying against one another.

In FIG. 2, the flange 12 of the heat shield 4 acts on the flange 10 of the bearing housing 2, but is, as already explained, not clamped between the flange 10 of the bearing housing 2 and the flange 6 of the turbine inflow housing 1. The flange 12 of the heat shield 4 in FIG. 2 acts on the flange 10 of the bearing housing 2 via an anti-rotation device 21. In FIG. 2, the number of the components in the bracing combination between bearing housing 2 and turbine inflow housing 1 is further reduced.

With the first aspect of the invention it is likewise possible to form the nozzle ring 3 as an integral part of the insert piece 11. In this case, the nozzle ring 3 then need not be separately fastened to the turbine inflow housing 1. Then it is rather the insert piece 11 which provides the nozzle ring 3 as an integral assembly that assumes the receiving of the same in the turbine.

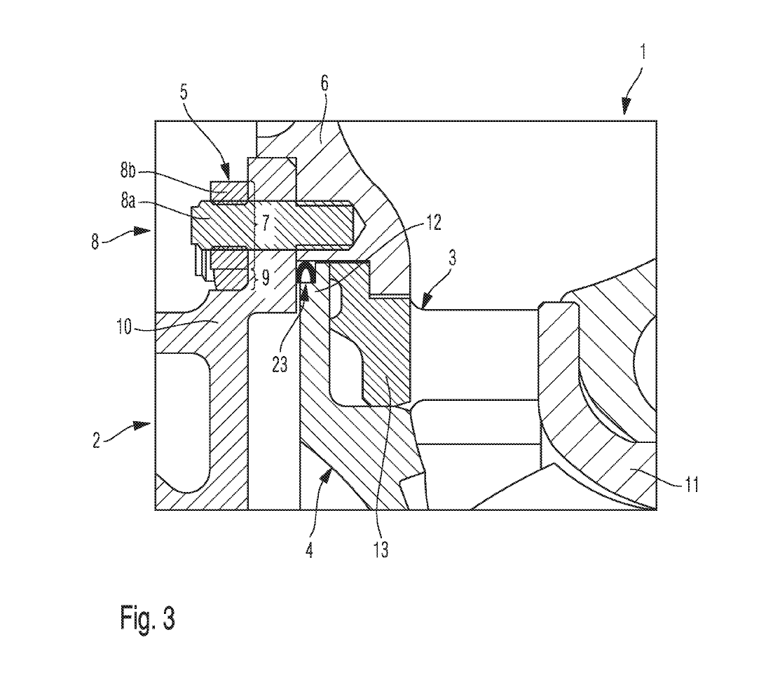

FIG. 3 shows a turbocharger according to an aspect of the invention. In FIG. 3, as is usual in the prior art, the flange 13 of the nozzle ring 3 and the flange 12 of the heat shield 4 are both clamped between the flange 14 of the bearing housing 2 and the flange 6 of the turbine inflow housing 1, namely via the clamping force exerted on this bracing combination via the fastening device 5.

According to an aspect of the invention a spring element 22 is positioned between the flange 10 of the bearing housing 2 and the flange 6 of the turbine housing 1, which spring element 22 presses the flange 13 of the nozzle ring 3 axially against the flange 6 of the turbine inflow housing 1. In FIG. 3, this spring element 22 is arranged between the flange 10 of the bearing housing 2 and the flange 12 of the heat shield 4, so that the spring element 22 presses the flange 12 of the heat shield 4 against the flange 13 of the nozzle ring 3 and accordingly the flange 13 of the nozzle ring 3 against the flange 6 of the turbine inflow housing 1.

In the process, the spring element 22 on the one side supports itself on the flange 10 of the bearing housing 2 and on the other side on the flange 12 of the heat shield 4. As already explained, the spring element 22 presses the flange 13 of the nozzle ring 3 in the axial direction against the flange 6 of the turbine inflow housing 1, as a result of which, even in particular when these assemblies during the operation are subjected to different thermal expansion, a good sealing effect in the connecting region of bearing housing 2 and turbine inflow housing 1 is always ensured, so that there is no risk that exhaust gas flows via this connecting region outside into the surroundings.

According to the previously explained second aspect of the invention, special bracing devices, such as clamping claws, can be additionally omitted. The flange of the bearing housing is directly screwed to the turbine inflow housing. This produces an unambiguous sealing face between flange 10 and flange 6 via which the entire force flow of the fastening elements 8 extends. The clamping of heat shield and nozzle ring can then be effected via a spring element 23.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A turbocharger, comprising:
a turbine configured to expand a first medium, comprising:
a turbine housing;
a nozzle ring; and
a turbine rotor;
a compressor configured to compress a second medium utilizing energy extracted in the turbine during an expansion of the first medium, comprising:
a compressor housing; and
a compressor rotor coupled to the turbine rotor via a shaft;
a bearing housing in which the shaft is mounted that is arranged between and connected to the turbine housing and the compressor housing;
a fastening device configured to connect the turbine housing and the bearing housing, comprising:
a first section of the fastening device that is mounted on a flange of the turbine housing; and
a second section of the fastening device covers a flange of the bearing housing at least in sections; and
a flange of the nozzle ring that is installed such that, based on a flow passage, the flange is positioned on a side of a flow passage that is located opposite the flange of the turbine housing.

15. The turbocharger according to claim 14, wherein the flange of the nozzle ring and the nozzle ring is an integral part of an insert piece of the turbine.

16. The turbocharger according to claim 15, wherein the flange of the nozzle ring adjoins a section of the turbine housing which, based on the flow passage, is positioned on the side of the flow passage that is located opposite the flange of the turbine housing.

17. The turbocharger according to claim 16, wherein the flange of the nozzle ring is fastened to the section of the turbine housing via a fastening device.

18. The turbocharger according to claim 16, further comprising:
an elastic spring element is received in a recess defined in the section of the turbine housing, which presses against the flange of the nozzle ring.

19. The turbocharger according to claim 18, wherein the elastic spring element presses the nozzle ring against a heat shield of the turbine.

20. The turbocharger according to claim 19, wherein a flange of the heat shield is clamped between the flange of the turbine housing and the flange of the bearing housing.

21. The turbocharger according to claim 19, wherein a flange of the heat shield is mounted to the flange of the bearing housing via an anti-rotation device.

22. The turbocharger according to claim 20, wherein the flange of the turbine housing directly lies against the flange of the bearing housing.

23. A turbocharger, comprising:
a turbine configured to expand a first medium, comprising:
a turbine housing; and
a turbine rotor,;
a compressor configured to compress a second medium utilising energy extracted in the turbine during an expansion of the first medium, comprising:
a compressor housing; and
a compressor rotor that is coupled to the turbine rotor via a shaft;
a bearing housing that is arranged between and connected to the turbine housing and the compressor housing and in which the shaft is mounted;
a fastening device configured to connect the turbine housing and the bearing housing, comprising:
a first section of the fastening device is mounted to a flange of the turbine housing; and
a second section of the fastening device covers a flange of the bearing housing at least in sections;
a flange of a nozzle ring and a flange of a heat shield are clamped between the flange of the turbine housing and the flange of the bearing housing; and
a spring element is positioned between the flange of the bearing housing and the flange of the turbine housing configured to press the flange of the nozzle ring axially against the flange of the turbine housing.

24. The turbocharger according to claim 23, wherein the spring element is positioned between the flange of the bearing housing and the flange of the heat shield, which presses the flange of the heat shield axially against the flange of the nozzle ring and presses the flange of the nozzle ring axially against the flange of the turbine housing.

25. The turbocharger according to claim 24, wherein the spring element is positioned in a recess of the flange of the heat shield between the flange of the heat shield and the flange of the bearing housing.

26. The turbocharger according to claim 25, wherein the spring element on one side supports itself on the flange of the heat shield and on an other side on the flange of the bearing housing.

27. The turbocharger according to claim 17, wherein the fastening device is a feather key.
